(19) United States
(12) Patent Application Publication
(10) Pub. No.: US 2001/0018112 A1
(43) Pub. Date: Aug. 30, 2001

(54) Headlining for a motor vehicle roof

(76) Inventors: Christoph Tobias Lante, Starnberg (DE); Martin Kralik, Weilheim (DE); Mauricio Kurpjuweit, Munchen (DE)

Correspondence Address: NIXON PEABODY, LLP, 8180 GREENSBORO DRIVE, SUITE 800, MCLEAN, VA, 22102, US

(21) Appl. No.: 09/732,930

(22) Filed: Dec. 11, 2000

(30) Foreign Application Priority Data
Dec. 9, 1999 (DE) 199 59 543.7

(51) Int. Cl. B32B 3/30

(52) U.S. Cl. 428/167; 428/174

(57) ABSTRACT

A headlining for attachment to a motor vehicle roof has an essentially rigid base structure with at least one predetermined folding line that is divided into at least two spaced partial folding lines in an arched headlining section of the base, an at least partially flexible cover layer which faces the interior of the motor vehicle, so that an edge section of the headlining can be bent or folded downward.

### BACKGROUND OF THE INVENTION

1. Field of the Invention

The invention relates generally to a headlining for a motor vehicle roof. More particularly, the invention relates to a headlining including an essentially rigid base structure, an at least partially flexible cover layer which faces the vehicle interior, and at least one predetermined folding line on which the headlining section for mounting on the motor vehicle roof can be bent or folded down towards the cover layer.

2. Description of the Related Art

German Patent DE 197 09 016 C2 discloses a motor vehicle roof made of a sandwich type construction, and on its inner shell, a roof headlining which is matched to the shape of the vehicle roof. The vehicle roof is produced separately from the vehicle body, and with its outside edges can be placed on the body frame of the vehicle body and can be joined securely to it. The headlining can be bent downward to the inside with partial folding in the corner areas for passage through the body roof opening which is bordered by the body frame during installation. Predetermined folding sites can be provided on the headlining to facilitate the transient bending of the edge areas of the headlining down and folding on the four corners of the vehicle roof. This is accomplished using notch-like depressions at the bending or folding sites on the side away from the surface of the headlining, which run along an almost bulge-free plane on the vehicle roof.

### SUMMARY OF THE INVENTION

Accordingly, an object of the invention is to overcome the disadvantages of the prior art in devising a motor vehicle roof headlining in which bending or folding of the headlining sections is accomplished using a three-dimensionally shaped headlining without significant over stretching or damage of the cover layer.

Another object of the invention is to devise a motor vehicle roof headlining having predetermined folding lines which are optically inconspicuous after installing the headlining.

The objects of the invention are achieved using a predetermined folding line divided into two spaced partial lines in the arched headlining section. The two partial folding lines ensure that the headlining, when folded down along the edge section, can be adapted such that the headlining parts which move in opposite directions in the bulged-down lower sections of the head lining, move around a raised pivoting- or bending-line which is located in the highest plane of the headlining without mutually penetrating one another, as would be the case without the divided partial folding lines. Accordingly, folding down the essentially rigid headlining is enabled and the lower cover layer is not unduly stretched. After the edge section is folded back an adverse optical effect at the predetermined folding site cannot be detected.

Moreover, the objects of the invention are achieved using a base structure in the area of the predetermined folding line which contains a stretching means which keeps the cover layer in the folded-back installed position of the headlining tensioned or stretched. In particular, the stretching means on the predetermined folding line tightens the cover layer comprising a cloth covering or a foam rubber layer, so that the site of completed bending with the headlining installed cannot be visually recognized. The stretching means can also be used on one of the partial folding lines when it is formed as a slot or a notch in the base structure.

Preferably, the distance between the partial folding lines or notches increases with the vertically increasing distance of the partial folding lines or notches from the theoretical bending line for the edge section of a headlining which can be folded down. In this way the maximum possible matching of the bending behavior of the bendable edge parts of the headlining is enabled even with a headlining which is structured by obvious elevations and depressions.

Feasibly the headlining is designed such that an intermediate piece of the headlining between the partial folding lines or notches when the edge section of the headlining is folded down is pivoted such that the one notch approaches the theoretical bending line and opens and that the other notch closes. By matching the bending line which forms to the theoretical bending line, bending of the edge areas of the headlining as free of over stretching as possible is enabled.

In the following, embodiments of the invention are detailed with respect to the drawings.

### BRIEF DESCRIPTION OF THE DRAWINGS

FIG. 1 is a schematic perspective view of a headlining for a motor vehicle roof;

FIG. 2 is a cross-sectional view of a portion of a headlining with a predetermined folding line taken along line A-A in FIG. 1;

FIG. 3 is a cross-sectional view of a headlining with a double predetermined folding line taken along the line B-B in FIG. 1;

FIG. 4 is a cross-sectional view of a headlining with a turned-down edge area taken along line B-B in FIG. 1;

FIG. 5 is a cross-sectional view of one embodiment of the configuration of the predetermined folding lines taken along line B-B in FIG. 1;

FIG. 6 is a cross-sectional view of another embodiment of the configuration of the predetermined folding lines taken along line B-B in FIG. 1;

FIG. 7 is a cross-sectional view of a further embodiment of the configuration of the predetermined folding lines taken along line B-B in FIG. 1;

FIG. 8 is a cross-sectional view of the headlining with the edge section not folded down taken along line B-B in FIG. 1;

FIG. 9 is a cross-sectional view of the headlining shown in FIG. 8 with the edge section folded down;

FIG. 10 is a cross-sectional view of a headlining with a predetermined folding line and a bent-down edge area;

FIG. 11 is a cross-sectional view of the headlining with the edge area folded back in the installed position; and

FIG. 12 is a perspective view of a headlining with a stretching means on the predetermined folding site.

### DETAILED DESCRIPTION OF THE INVENTION

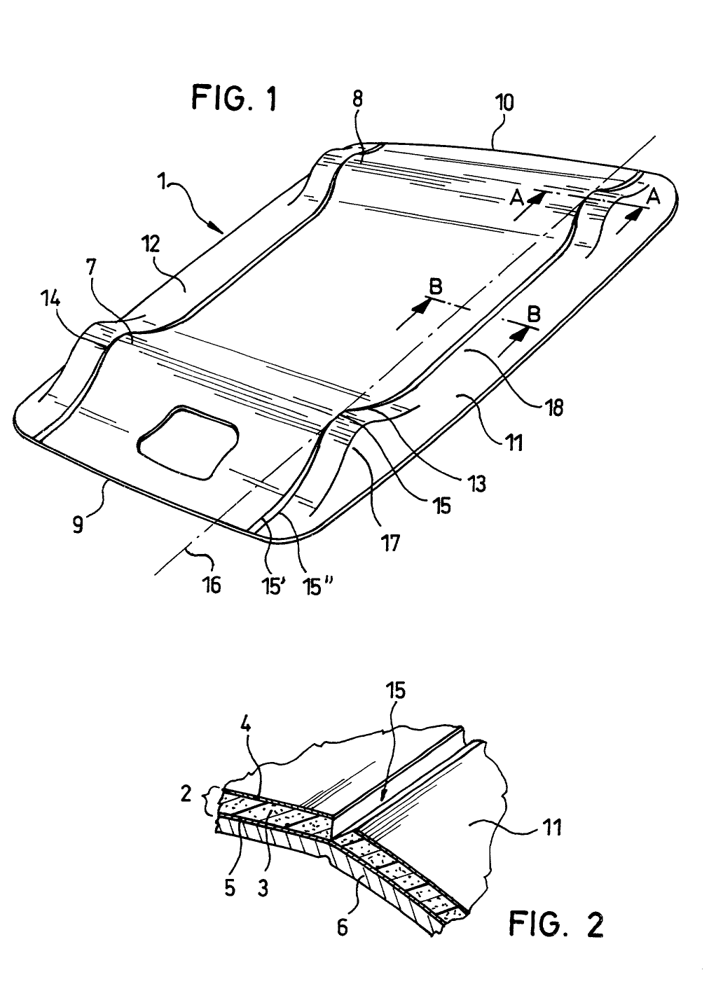

Referring now to the drawings, FIGS. 1 & 2 show a headlining 1 for a vehicle such as a motor vehicle, i.e., a passenger car, having a top-side base structure 2 which, in the installed position of the headlining 1, faces the vehicle roof or the roof surface of a roof module. The base structure 2 is comprised of a hardened foam layer 3, and top and bottom glass fiber mats or glass fiber layers 4, 5 which are attached on each side of the hardened foam layer 3 and form a sandwich-like structure which provides a hard, rigid and essentially unbending base structure 2. The headlining 1, on its bottom surface which faces the vehicle interior, has at least a partially flexible cover layer 6 that includes a fabric or a fabric with a foam substrate, and is cemented to the base structure 2.

As shown in FIG. 1, the headlining 1 is matched to its inside contour and has two raised or elevated areas 7, 8 which run near the front end 9 and the back end 10 transversely over the headlining 1 and almost to the side edge of the head lining. The front raised area 7 is used for lowered accommodation of two visors, while the rear raised area 8 enlarges the free head space for rear vehicle passengers. The headlining 1 also includes two lateral edge sections or edge areas 11, 12 which cover the side members of the frame of the vehicle roof (not shown). So that the headlining 1 can be inserted as part of a prefabricated roof module, during installation from overhead into a motor vehicle roof, the two edge areas 11, 12 can be bent or folded down so that the headlining 1 can be inserted through an opening which has been cleared by the roof frame and which is smaller than the headlining 1.

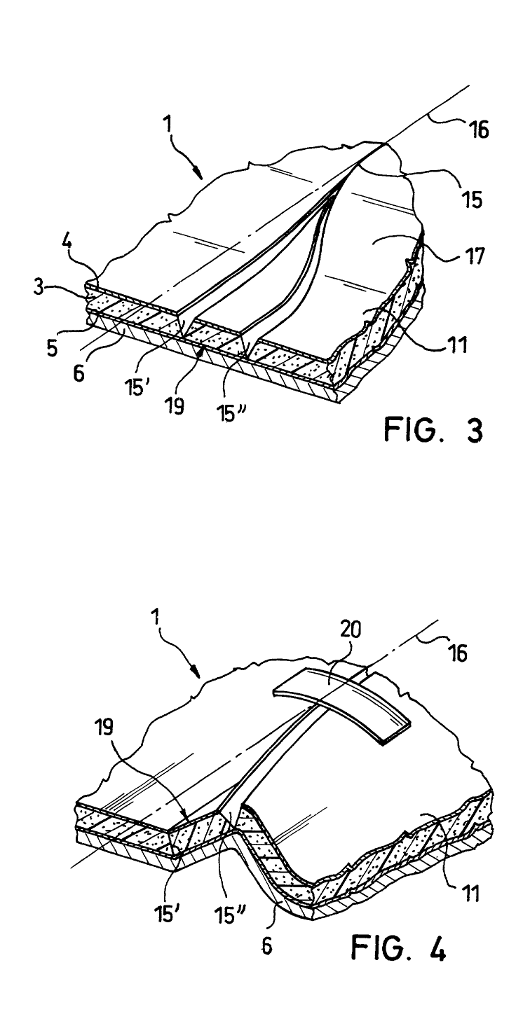

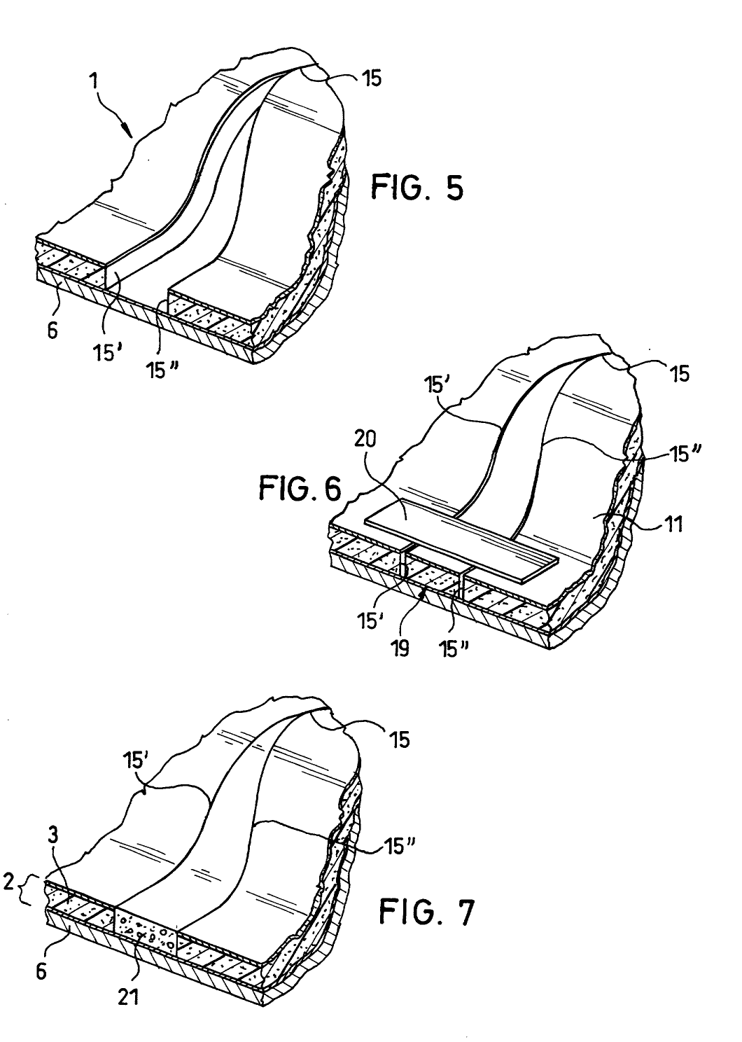

For this purpose, the headlining 1 contains two predetermined folding sites or lines 13, 14 which run lengthwise and on which the respective edge area 11 or 12 can be folded down. The predetermined folding line 13, 14 is formed as a notch 15 in the base structure 2 which separates the upper glass fiber layer 4 and the hardened foam layer 3, but not the lower glass fiber layer 5. The notch 15 is formed in the raised areas 7, 8 of the headlining 1 and coincides with a theoretical bending line 16 which as the lengthwise tangent adjoins the highest points of the raised areas 7, 8. In arched sections 17 which adjoin the raised areas 7, 8 towards the front end 9 or the back end 10 of the headlining 1, or towards the lowered intermediate area 18 between the two elevated areas 7, 8, the notch 15 is widened (see FIG. 5) or may be split into two separate or divided notches 15′, 15″ (see FIG. 3). When the edge section 11 is bent downward, the notch 15 opens in the raised areas 7, 8 (see FIG. 2).

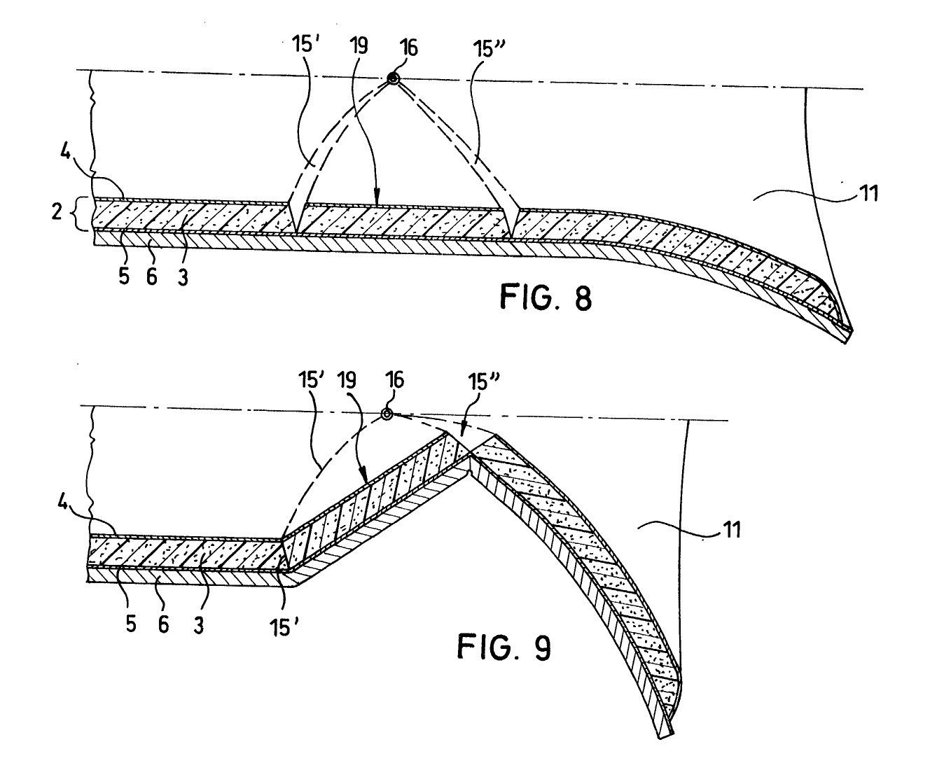

As shown in FIGS. 4, 8, and 9, in the segments of the predetermined folding line 13, 14 which are spaced vertically away from a theoretical bending line 16, an intermediate piece 19 may be inserted between the notches 15′, 15″ and is shaped such that notch 15″ approaches the theoretical bending line 16, and in doing so opens, while the other notch 15′ closes. Each notch 15, 15′ and 15″ can be formed as straight, narrow or wide cuts or punch-outs, or may be shaped in a U-shaped or V-shaped notch form.

The distance between the two separate notches 15′ and 15″ increases with the magnitude of the vertical distance of the notches 15′, 15″ from the theoretical bending line 16 so that when the edges 11, 12 are bent downward there is always at least one notch 15′, 15″ in the vicinity of the theoretical bending line 16. As a result, bending of the headlining 1 and bulges are enabled without over stretching or damaging the cover layer 6 on the predetermined folding lines 13, 14 or notches 15, 15′, 15″. Even if the base structure 2 is essentially rigid, the headlining 1 can have a certain flexibility which supports bending without over stretching the cover layer 6. In a vertical overhead view of the headlining 1, the two predetermined folding lines or notches 15′ and 15″ are located substantially symmetrical to the theoretical or imaginary bending line 16, or one of the notches 15′, 15″ lies closer in distance to the bending line 16 than the other notch 15′, 15″.

The edge sections 11, 12 are bent over against the restoring force of the lower glass fiber layer 5 which is elastically deformed when being bent over, or if the notch 15 does not cut entirely through the hardened foam layer 3, the glass fiber layer 5 and a portion of the hardened foam layer 3. During installation, the edge sections 11, 12 are held in a downward position. After positioning the headlining 1 in its installed position on the vehicle roof, the edge sections 11, 12 are folded or bent back by the restoration force into an unfolded neutral position. The cover layer 6 is thus tensioned on the predetermined folding line and is in its original shape.

As shown in FIGS. 4 and 6, in another embodiment of the invention, an elastic tensioning element 20 is attached on the top of the base structure 2 so that the top glass fiber layer 4 reaches over the notch 15 or the separated notches 15′, 15″. The tensioning element 20 offers an additional restoration force for bending back the edge sections 11, 12 if the restoration force of the base structure 2 or the glass fiber mat 5 is not sufficient or adequate. The tensioning element 20 may comprise a rubber band element or any device capable of recovering its size and shape after deformation.

As shown in FIG. 5, the base structure 2 can be removed from the intermediate piece 19 between the two separate notches 15′, 15″, thereby ensuring the flexible deformability of the section. Alternatively, instead of the base structure 2 being inserted between the separate notches 15′, 15″, there can be an elastic material 21 which differs in structure from the base structure 2, and can be compressed and retain a restoring force such as a foam material. The elastic material 21 can be worked in during the production of the base structure 2. In this embodiment, the notches 15, 15′, 15″ are not actual notches, but simply are formed by the material transition lines. In addition, the elastic material 21 can be inserted in place of the intermediate piece 19 which has been cut out between the separate notches 15′, 15″.

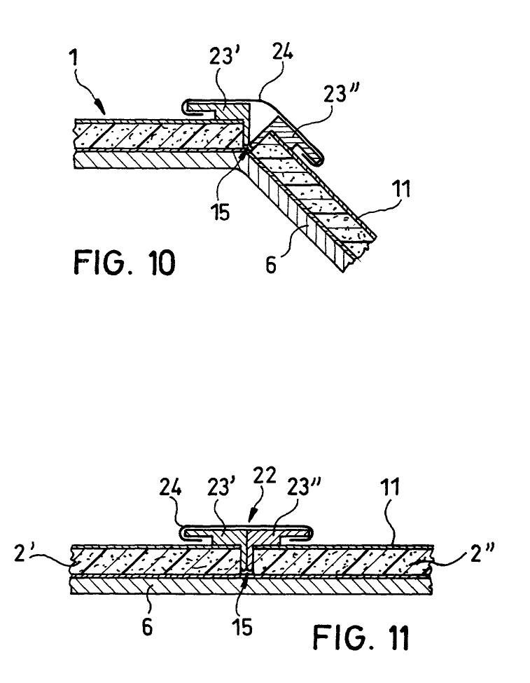

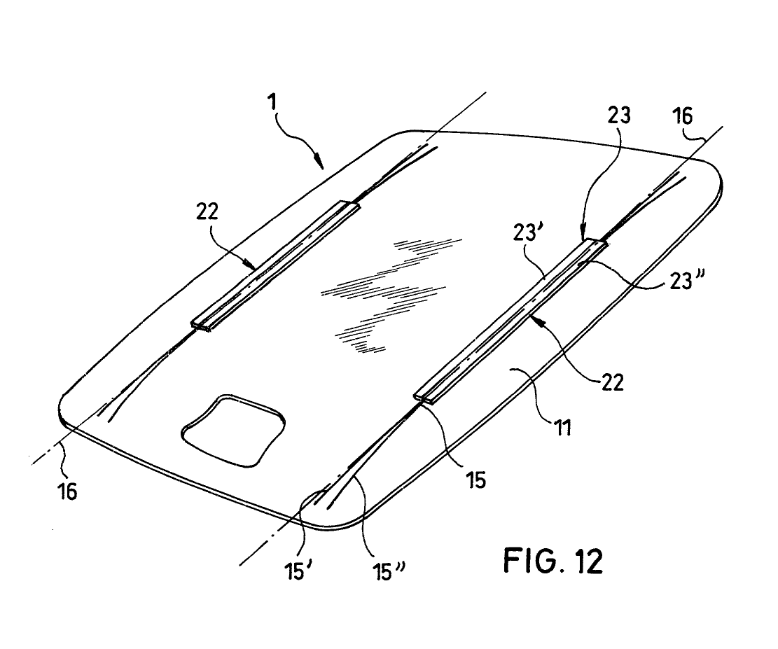

FIGS. 10, 11 & 12 show an embodiment of the headlining 1 in which a stretching means 22 is inserted into the notch 15 with the bent-down edge section 11. The notch 15 is produced with a gap width of approximately 1 mm in a comparably flat section of the headlining 1. The stretching means 22 includes a two-part profile strip 23′, 23″ with a total thickness in the range of from about 1.1 to about 1.5 mm. Each profile strip 23′, 23″ may be cemented to the respective cut surface of the base structure 2. When the edge section 22 is folded back, the profile strips 23′, 23″ adjoin one another and spread apart the two bordering base structure parts 2′, 2″ relative to the notch 15 so that the lower flexible cover layer 6 is tensioned and stretched. This stretching at the predetermined folding site prevents the predetermined folding site from being visible as an optical irregularity of the cover layer 6 in the installed position of the headlining 1. Moreover, a tensioning means 24 provided in the form of a rubber band or the like is tensioned over the two top sides of the profile strip 23′, 23″ and is attached thereto for the folding back of the edge section 11 which has been bent down.

The stretching means 22 may comprise a metal or plastic spring means or an elastically compressible and subsequently re-expanding foam. Depending on the roof configuration and the installation requirements, at least one raised area 7, 8 can also be made to run in the lengthwise direction and the respective predetermined folding line can run in the cross direction for folding down the front or the rear edge area.

While the present invention has been described in connection with what is considered to be the most practical embodiments, it is understood that this invention is not limited to the disclosed embodiments and may reasonable encompass various arrangements included with in the spirit and scope of the broadest interpretations and equivalent arrangements.

We claim:

1. A headlining for attachment to a motor vehicle roof, said headlining comprising:
an essentially rigid base structure;
an essentially flexible cover layer mounted on a lower side of the an essentially rigid base structure which faces an interior section of the motor vehicle in an installed condition of the headlining; and
at least one predetermined folding line for allowing a section of the headlining to be folded downward with the substantially flexible cover layer being at an inner side of the downwardly folded section;
wherein the headlining has an arched headlining section; and wherein said predetermined folding line is divided into two spaced, partial folding lines in the arched headlining section.

2. The headlining as claimed in claim 1, wherein said at least one predetermined folding line is formed by at least one notch on an upper surface of said essentially rigid base structure.

3. The headlining as claimed in claim 1, wherein the spacing between the spaced, partial folding lines increases with the magnitude of a vertical distance between said spaced, partial folding lines and a bending axis lying at an apex of the arched headlining section, such that an edge section of said headlining can be folded downward.

4. The headlining as claimed in claim 2, wherein the spacing between the spaced, partial folding lines increases with the magnitude of a vertical distance between said spaced, partial folding lines and a bending axis lying at an apex of the arched headlining section, such that an edge section of said headlining can be folded downward.

5. The headlining as claimed in claim 1, further comprising an intermediate piece inserted between said spaced, partial folding lines.

6. The headlining as claimed in claim 5, wherein said spaced, partial folding lines are formed by notches; and wherein said intermediate piece is shaped such that, when said edge section is folded downward, a first of said notches moves toward the bending axis and opens while a second of said notch closes.

7. A headlining for attachment to a motor vehicle roof, said headlining comprising:
an essentially rigid base structure;
an essentially flexible cover layer on a lower side of the an essentially rigid base structure which faces an interior section of the motor vehicle in an installed condition of the headlining; and
at least one predetermined folding line for allowing a section of the headlining to be folded downward with the substantially flexible cover layer being at an inner side of the downwardly folded section;
wherein said essentially rigid base structure includes stretching means for maintaining said cover layer in at least one of a tensioned and stretched position when said headlining is placed in a folded-back position, said stretching means being mounted crosswise of said at least one predetermined folding line.

8. The headlining as claimed in claim 7, wherein said stretching means is mounted in a notched section of an upper surface of said essentially rigid base structure.

9. The headlining as claimed in claim 8, wherein said stretching means comprises a two-part profile strip material.

10. The headlining as claimed in claim 7, wherein said stretching means comprises a two-part profile strip material.

11. The headlining as claimed in claim 7, wherein said stretching means is an elastic foam.

12. The headlining as claimed in claim 8, wherein said stretching means is an elastic foam.

13. The headlining as claimed in claim 8, wherein said notched section comprises a first notch and a second notch.

14. The headlining as claimed in claim 13, further comprising an intermediate piece inserted between said first notch and said second notch.

15. The headlining as claimed in claim 14, wherein said intermediate piece is shaped such that, when said edge section is folded downward, said first notch moves toward the bending axis and opens while said second notch closes.
